(19) United States
(12) Patent Application Publication
(10) Pub. No.: US 2024/0305055 A1
(43) Pub. Date: Sep. 12, 2024

(54) ELECTRIC TOOL

(71) Applicant: MAXELL IZUMI CO., LTD., Matsumoto-shi, Nagano (JP)

(72) Inventor: Masaki MIYAZAWA, Matsumoto-shi, Nagano (JP)

(21) Appl. No.: 18/280,796

(22) PCT Filed: May 23, 2022
(86) PCT No.: PCT/JP2022/021038

§ 371 Date: Sep. 7, 2023

(30) Foreign Application Priority Data
Jun. 7, 2021 (JP) 2021-095033

(51) Int. Cl. H01R 43/042

(52) U.S. Cl. CPC H01R 43/0428; H01R 43/0421

(57) ABSTRACT

An electric tool is configured to crimp the work with constant force. The electric tool includes a body having an electric motor, a feed screw, a slide part, and a control part; and a tool head having a first jaw part and a second jaw part that are connected to the body, and are pivotably connected to each other. The slide part is provided with a first roller and a second roller.

### TECHNICAL FIELD

The present invention relates to an electric tool for processing a work.

### BACKGROUND ART

Conventionally, an electric tool having a configuration in which a crank-type gripping lever and an electric motor are combined is known (PTL 1: EP2872293). The electric tool of PTL 1 has a configuration in which the distal end side of the tool head is open in the initial state, and the distal end side of the tool head is closed by a gripping force of the operator gripping the gripping lever to hold the work. Then, when the gripping force exceeds a specified value, the electric motor is actuated to close the distal end side of the tool head to process the work.

### CITATION LIST

### Patent Literature

PTL 1: EP2872293

### SUMMARY OF INVENTION

### Technical Problem

When a crimping terminal and an electric wire are crimped at a work site, it is necessary to align the crimping terminal and the electric wire. Also, when a crimping sleeve is compressed to join electric wires together at a work site, it is necessary to align the sleeve with each electric wire.

However, with the electric tool of PTL 1, since it is necessary to align the crimping terminal and electric wire and to align the compression sleeve and electric wires while maintaining a state in which the gripping lever is gripped with a gripping force within a range not exceeding the specified value, the burden on the operator is significant. That is, when the gripping force on the gripping lever by the operator becomes below the specified value, the distal end side of the tool head opens, and there is a problem where the work, such as the compression terminal or the crimping sleeve, drops. On the other hand, when the gripping force on the gripping lever by the operator exceeds the specified value, the electric motor is actuated to start processing the work. This closes the distal end side of the tool head in a stage prior to the alignment of the work, resulting in the problem of poor processing of the compression terminal or crimping sleeve. Additionally, with the electric tool of PTL 1, since the distal end side of the tool head is open in the initial state, the tool needs to be handled with care so as not to accidentally injure the hand at the start of operation.

### Solution to Problem

The present invention is made in view of the above described circumstances, and it is an object of the present invention to provide an electric tool that has a configuration that can easily align a work by holding the work with a constant force and process the work in the aligned state, and has a structure that can reduce the burden on the operator and has a high level of safety.

The present invention has been accomplished under the solutions as disclosed below.

An electric tool according to the present invention includes: a main body including an electric motor, a feed screw to be actuated by the electric motor, a slide part to be moved by the feed screw, and a control part; and a tool head that is coupled to the main body and includes a first jaw and a second jaw pivotally coupled to each other, wherein the tool head is provided with a spring that urges a distal end side of the first jaw and a distal end side of the second jaw in directions toward each other, and processes a work with a first shape part on the distal end side of the first jaw and a second shape part on the distal end side of the second jaw, the slide part is provided with a first roller at a position slidable to a rear end side of the first jaw, and provided with a second roller at a position slidable to a rear end side of the second jaw, when the slide part is at an intermediate position, the rear end side of the first jaw and the first roller are separated, the rear end side of the second jaw and the second roller are separated, and the distal end side of the first jaw and the distal end side of the second jaw are urged by the spring and closed, and by retracting and moving the slide part, the first roller slides on the rear end side of the first jaw, the second roller slides on the rear end side of the second jaw, and the first shape part and the second shape part are brought closer to each other to process the work.

According to this configuration, since the distal end side of the tool head is closed in the initial state in which the slide part is at the intermediate position, the level of safety is high. Also, since the control part can drive and control the electric motor to move the slide part with the feed screw and hold the work, the work can be easily aligned. Then, the work can be processed accurately and reliably by the movement of the slide part. As such, a structure is achieved that, as compared to conventional products, reduces the burden on the operator and has a high level of safety.

An electric tool according to the present invention includes: a main body including an electric motor, a feed screw to be actuated by the electric motor, a slide part to be moved by the feed screw, and a control part; and a tool head that is coupled to the main body and includes a first jaw and a second jaw pivotally coupled to each other, wherein the tool head is provided with a spring that urges a distal end side of the first jaw and a distal end side of the second jaw in directions toward each other, and processes a work with a first shape part on the distal end side of the first jaw and a second shape part on the distal end side of the second jaw, the slide part is provided with a first roller at a position slidable to a rear end side of the first jaw, and provided with a second roller at a position slidable to the a rear end side of the second jaw, and the control part performs control that, after retracting and moving the slide part to a position that can process the work and then processing the work, advances and moves the slide part to a position that allows the processed work to be removed.

According to this configuration, since the control part can drive and control the electric motor to move the slide part with the feed screw and hold the work, the work can be easily aligned. Also, the work can be processed accurately and reliably by the movement of the slide part. After processing, the distal end side of the tool head is opened so that the work can be removed. As such, a structure is achieved that, as compared to conventional products, reduces the burden on the operator and has a high level of safety.

The tool head is provided with the spring that urges the distal end side of the first jaw and the distal end side of the second jaw in directions toward each other. According to this configuration, it is possible to securely hold the work with a constant force while making the configuration simpler than a crank or a link. Since the distal end side of the tool head is closed in the initial state, the level of safety is high.

The second jaw is preferably provided with an operation part that, when operated by the operator while the slide part is at the intermediate position, separates the first shape part and the second shape part from each other so as to allow the work to be removed. According to this configuration, when the operator presses the operation part of the second jaw while the slide part is at the intermediate position, the distal end side of the second jaw is separated from the distal end side of the first jaw. This facilitates the attachment of the work and the alignment of the work. As a result, a configuration that is easy to use can be achieved. In one example, the main body has a cover part, and a guide plate, which corresponds in shape to a finger of the operator, is attached to the position of the operation part of the second jaw that is pressed by the operator. As the cover part, a resin molded product, or a metal pressed product having an inner wall with insulating treatment may be used.

The main body is preferably provided with a trigger switch that is actuated in conjunction with a trigger lever operated by the operator so that the control part drives the electric motor, and a control switch that is actuated by operation by the operator so that the control part enables actuation of the trigger switch. The intermediate switch is preferably actuated by movement of the slide part to the intermediate position so that the control part stops the electric motor, when the slide part is at the intermediate position, the rear end side of the first jaw and the first roller are preferably separated, and the rear end side of the second jaw and the second roller are preferably separated. According to this configuration, while the simple configuration in which the control switch and the trigger switch are combined is provided, the operator can easily perform a series of necessary operations with one hand, with consideration given to safety. As a result, a configuration that is easy to use can be achieved.

The main body preferably includes a trigger switch, a control switch, and an intermediate switch that is actuated by movement of the slide part to the intermediate position, and, in response to the control switch being operated by the operator when the intermediate switch is in an ON state, the control part preferably performs control that switches between an automatic mode that repeatedly performs operation of processing the work from a state in which the distal end side of the first jaw and the distal end side of the second jaw are open, and a manual mode that performs operation of processing the work one by one from a state in which the distal end side of the first jaw and the distal end side of the second jaw are closed. Also, in response to the trigger switch being operated by the operator, the control part preferably drives and controls the electric motor, processing of the work preferably becomes possible when the trigger switch is in an ON state, in response to the intermediate switch being actuated, the control part preferably performs stop control of the electric motor, and removal of the processed work preferably becomes possible when the electric motor is in a stopped state.

The main body is preferably provided with an upper limit switch that is actuated by movement of the slide part to an upper limit position so that the control part stops the electric motor, an intermediate switch that is actuated by movement of the slide part to the intermediate position so that the control part stops the electric motor, and a lower limit switch that is actuated by movement of the slide part to a lower limit position so that the control part stops the electric motor. According to this configuration, although it is a simple configuration in which a plurality of switches are arranged, it is possible to prevent a greater load than is necessary from being applied to the tool head, allowing the desired control to be performed accurately and reliably. The main body preferably includes a lower limit switch that is actuated by movement of the slide part to a lower limit position, and an upper limit switch that is actuated by movement of the slide part to an upper limit position, when the lower limit switch is in an ON state, the work is in a processed state, and after the work is processed, removal of the processed work becomes possible when the upper limit switch is in an ON state.

In one example, the feed screw is supported by a bearing and coupled to the electric motor via a speed reducer. According to this configuration, it is possible to reduce the rotational friction generated by the load in the thrust direction received when the feed screw moves the slide part. One example is a slide part that is coupled to a nut with which rotational movement of the feed screw is converted into liner movement, or a slide part that is formed integrally with the nut. A ball screw may be used as the feed screw. The bearing is a thrust bearing, and a thrust ball bearing or a thrust roller bearing may be used, for example. Additionally, coupling the feed screw to the electric motor via the speed reducer facilitates the generation of high torque with a small electric motor. In one example, the speed reducer is a gearbox composed of a plurality of gears. The electric motor may be a geared motor having an integral structure combined with the speed reducer.

In one example, the main body includes a battery that supplies electric power to the electric motor and drives the electric motor with electric power from the battery to compress, crimp, or cut the work. This configuration eliminates the need for a power cord and allows the operation range to be enlarged. Accordingly, a compact, easy-to-use structure can be achieved. In one example, the cover part of the main body has the shape of a handle that can be gripped by the operator and extends in a direction away from the tool head. An adapter is provided below the handle-shaped cover part. In one example, the battery is connected to the adapter of the main body in the form of a battery pack.

### Advantageous Effects of Invention

According to the present invention, it is possible to easily align a work by holding the work with a constant force, and to easily process the aligned work. Also, since the distal end side of the tool head is closed in the initial state, it is possible to realize an electric tool with a structure that can reduce the burden on the operator and has a high level of safety as compared to conventional products.

### BRIEF DESCRIPTION OF DRAWINGS

FIG. 1 is a schematic perspective view showing an example of an electric tool according to an embodiment of the present invention.

FIG. 2A is a rear view of the electric tool shown in FIG. 1, FIG. 2B is a right side view of the electric tool shown in FIG. 1, FIG. 2C is a front view of the electric tool shown in FIG. 1, and FIG. 2D is a left side view of the electric tool shown in FIG. 1.

FIG. 3A is a schematic structural diagram showing a state in which a cover part is removed from the electric tool of FIG. 1, and FIG. 3B is a structural diagram showing the relationship between a trigger lever and a switch substrate of the electric tool of FIG. 1.

FIG. 4A is a front view of a tool head of the electric tool shown in FIG. 1, and FIG. 4B is a left side view of the tool head of the electric tool shown in FIG. 1.

FIG. 5 is an example of a schematic circuit diagram of the electric tool of the present embodiment.

FIG. 6A is a schematic structural diagram showing an initial state in a usage mode of the electric tool shown in FIG. 1, FIG. 6B is a schematic structural diagram showing a state in which a work is attached in the usage mode of the electric tool shown in FIG. 1, FIG. 6C is a schematic structural diagram showing a state in which the work is compressed or crimped in the usage mode of the electric tool shown in FIG. 1, and FIG. 6D is a schematic structural diagram showing a state in which the work is removed in the usage mode of the electric tool shown in FIG. 1.

### DESCRIPTION OF EMBODIMENTS

Referring to the drawings, embodiments of the invention are now described in detail. An electric tool 1 of the present embodiment drives an electric motor 7a with electric power from a battery 5 to compress, crimp, or cut a work 90. In one example, the electric tool 1 is used to crimp a crimping terminal and an electric wire at a work site, or to join electric wires by compressing a crimping sleeve at a work site. Throughout the figures illustrating embodiments, members having the same functions are denoted by the same reference numerals, and repeated description thereof may be omitted.

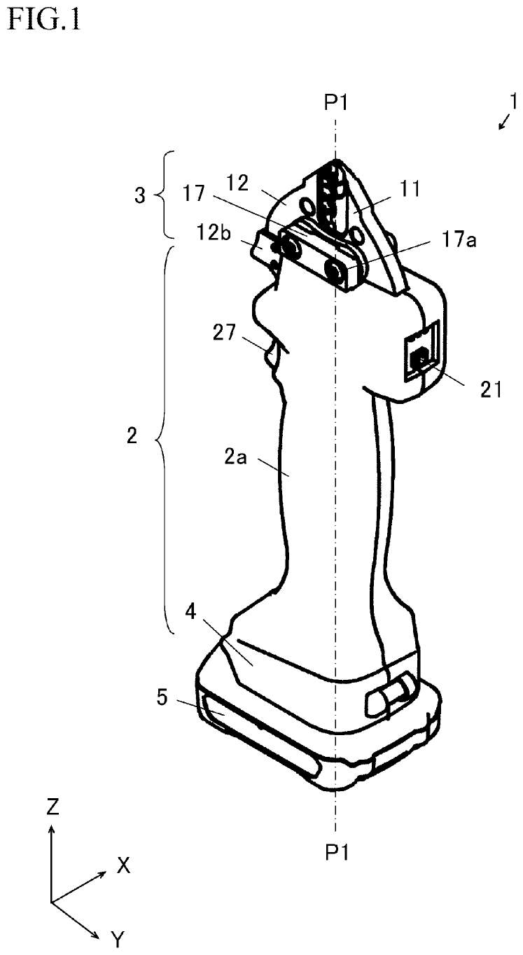

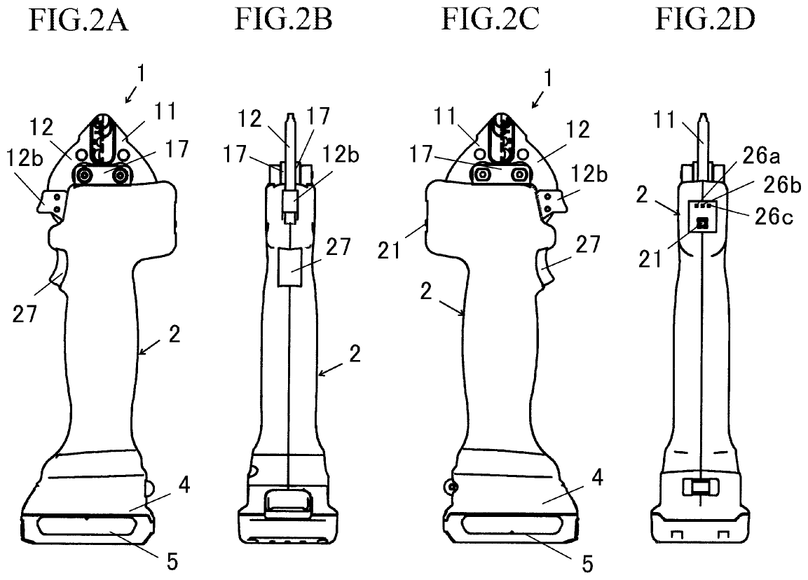

FIGS. 1, 2A, 2B, 2C, and 2D are schematic diagrams of an example of the electric tool 1 according to the present embodiment. The electric tool 1 includes a main body 2, which includes the electric motor 7a, a feed screw 8a, a slide part 9, a control part 19, and a control switch 21, a tool head 3, which is coupled to the main body 2 and includes a first jaw 11 and a second jaw 12 pivotally coupled to each other, and the battery 5, and is a cordless type tool that is hand-held by an operator at a work site. The slide part 9 reciprocates along an axis P1 of the feed screw 8a. The slide part 9 advances to an upper limit position in the direction of the Z-direction arrow in the drawing, and retracts to a lower limit position in the direction opposite to the Z-direction arrow in the drawing. In the initial state in which the slide part 9 is at an intermediate position, a distal end side of the tool head 3 is closed. The example of FIG. 1 is a multifunctional electric tool 1 with a replaceable tool head 3. Here, to facilitate the explanation of the positional relationship of parts of the electric tool 1, the directions are indicated by arrows of X, Y, and Z in the drawing. The electric tool 1 operates normally in any direction.

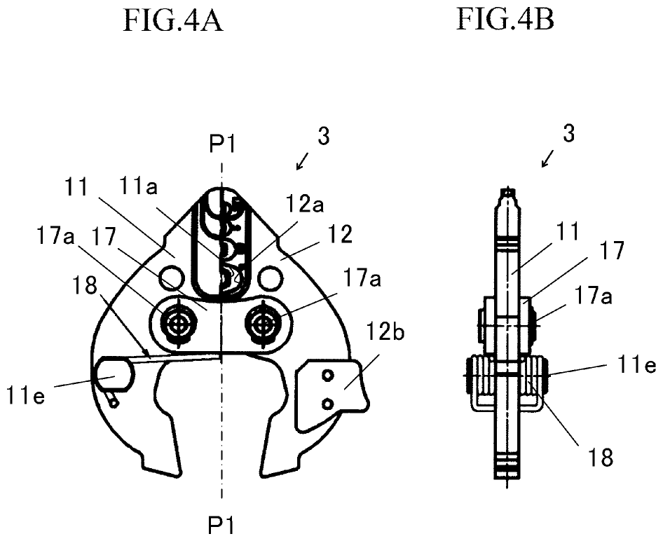

FIGS. 4A and 4B are examples of the tool head 3 for compression. The first jaw 11 and the second jaw 12 are individually supported by first shaft members 17a inserted therein and pivotally coupled to each other by a coupling bar 17. A first shape part 11a on a distal end side of the first jaw 11 faces inward and has protrusions formed at predetermined intervals, and a second shape part 12a on a distal end side of the second jaw 12 faces inward and has recesses, which are formed in one-to-one correspondence to the protrusions. Then, the first shape part 11a on the distal end side of the first jaw 11 and the second shape part 12a on the distal end side of the second jaw 12 are brought closer to each other to compress or crimp a compression terminal or a crimping sleeve as the work 90. A spring 18 is a torsion coil spring made of metal. A coil part of the spring 18 is pivotally attached to a support part 11e provided in the first jaw 11. An end portion of the spring 18 is in contact with the coupling bar 17. A restoring force of the spring 18 urges the first shape part 11a on the distal end side of the first jaw 11 and the second shape part 12a on the distal end side of the second jaw 12 in directions toward each other.

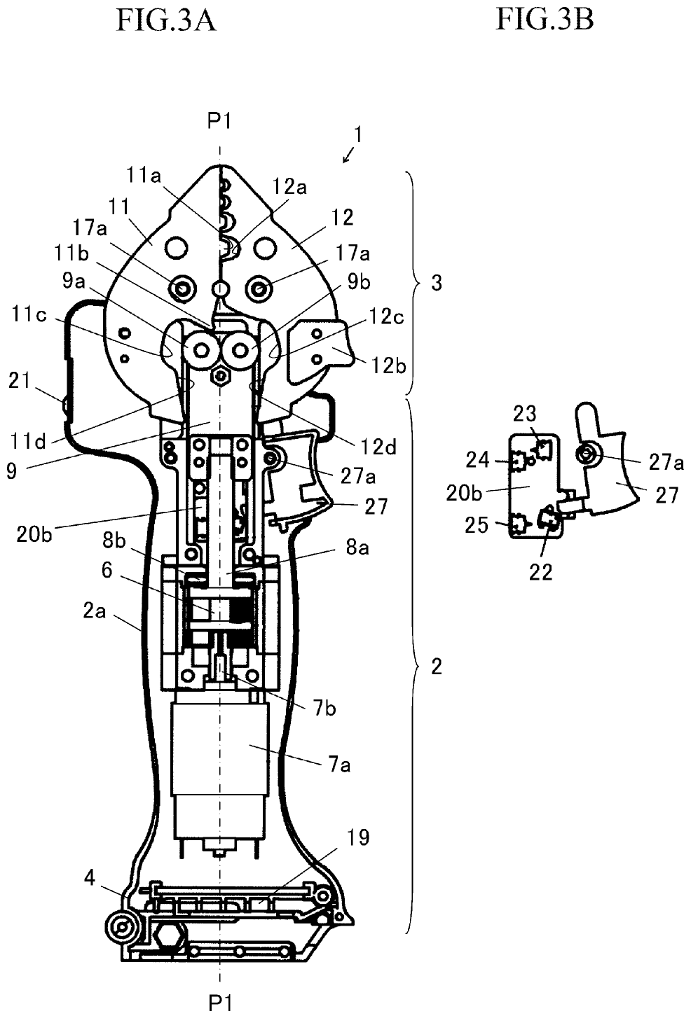

FIG. 3A is a schematic structural diagram showing a state in which a cover part 2a of the main body 2 of the electric tool 1 is removed, and FIG. 3B is a structural diagram showing the relationship between a trigger lever 27 and a switch substrate 20a of the electric tool 1. In one example, the control switch 21 is a push switch. The trigger lever 27 is pivotally supported by a second shaft member provided in the main body 2, and a trigger switch 22 is actuated in conjunction with the trigger lever 27. The trigger switch 22 is a microswitch. A plurality of microswitches capable of detecting the position of the slide part 9 are mounted on the switch substrate 20a. In one example, the position of the slide part 9 is detected when a pin provided on the slide part 9 comes into contact with the microswitch.

The tool head 3 processes the work 90 using the principle of leverage. The first jaw 11 has a first slide surface 11d, which is formed on a rear end side of the first jaw 11 and on which a first roller 9a slides, and a first curved part 11c extending from a projecting part 11b of the first jaw 11 to the first slide surface 11d has a hollowed shape so as to be separated from the first roller 9a. Also, the second jaw 12 has a second slide surface 12d, which is formed on a rear end side of the second jaw 12 and on which a second roller 9b slides, and a second curved part 12c extending from an inner edge part, which is adjacent to a location where the first shaft member is located, to the second slide surface 12d has a hollowed shape so as to be separated from the second roller 9b.

The feed screw Sa is supported by a bearing 8b and is coupled to the electric motor 7a via a speed reducer 6. The main body 2 has the battery 5 that supplies electric power to the electric motor 7a, and drives the electric motor 7a with electric power from the battery 5 to compress, crimp, or cut the work 90. The cover part 2a of the main body 2 has the shape of a handle that can be gripped by the operator and extends in a direction away from the tool head 3. An adapter 4 is provided on a lower end side of the cover part 2a, and the battery 5 is connected to the adapter 4 of the main body 2 in the form of a battery pack.

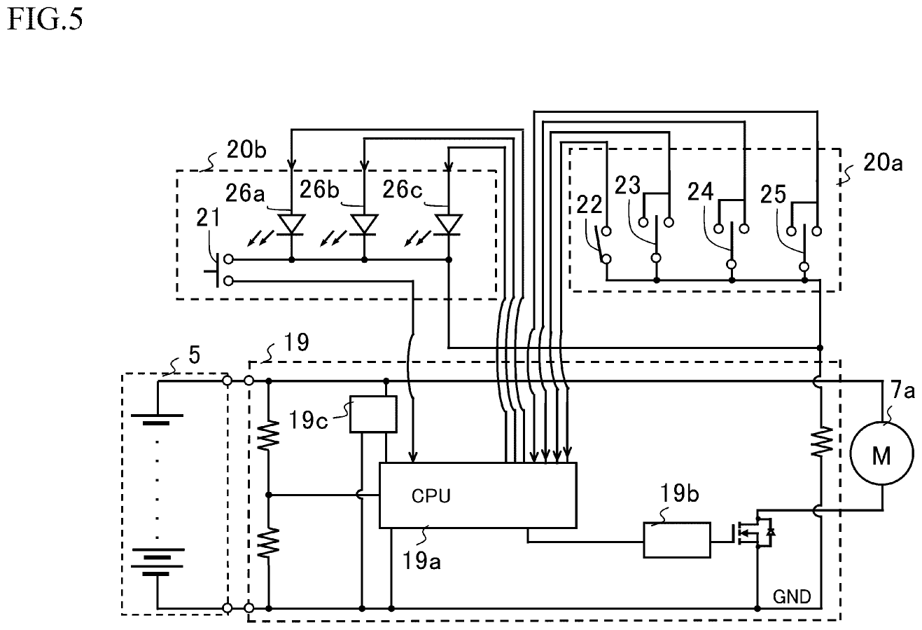

FIG. 5 is an example showing the configuration of a circuit diagram of the electric tool 1. The control part 19 has, for example, a CPU 19a formed by a one-chip microcomputer. Next, the control part 19, and the switch substrate 20a and an indication substrate 20b that constitute peripheral circuits are described below.

In one example, the battery 5 is a lithium ion battery with a power supply voltage of 7 to 42 [V] and a battery capacity of 1 to 10 [Ah]. The voltage of the battery 5 is stepped down via a regulator 19c and supplied to the CPU 19a. The CPU 19a checks and monitors the remaining amount of the battery 5 and also functions as a timer. In one example, the CPU 19a sends a PWM signal to a driver 19b, supplies power to the electric motor 7a through a drive element such as a power MOSFET, and controls and drives the electric motor 7a.

In one example, the control part 19, the switch substrate 20a, and the indication substrate 20b are signal-connected by wiring. On the switch substrate 20a, the trigger switch 22, which is actuated by operation of the trigger lever 27, an upper limit switch 23, which is actuated by the slide part 9 moving to the upper limit position, an intermediate switch 24, which is actuated by the slide part 9 moving to the intermediate position, and a lower limit switch 25, which is actuated by the slide part 9 moving to the lower limit position, are mounted. When an actuation signal of each switch is input to the CPU 19a, the CPU 19a drives and controls the electric motor 7a.

On the indication substrate 20b, the control switch 21 operated by the operator, an LED 26a that indicates that the electric tool 1 is in an automatic mode, an LED 26b that indicates that the electric tool 1 is in an abnormal state, and an LED 26c that indicates that the electric tool 1 is in a manual mode are mounted. When an actuation signal of the control switch 21 is input to the CPU 19a, the CPU 19a determines that an operation signal of the trigger switch 22 is a valid signal, and sets conditions for driving and controlling the electric motor 7a. In one example, the control switch 21 is a push switch, and when the intermediate switch 24 is ON and the control switch 21 is pressed for a predetermined period, for example, pressed for 3 seconds or longer, the mode is switched each time. The automatic mode is used for continuous operation, and the LED 26a lights up under the indication control of the CPU 19a to indicate green, for example. The manual mode is used for one-time operation, and the LED 26c lights up under the indication control of the CPU 19a and indicates green, for example.

When the electric tool 1 is in an abnormal state, an abnormal signal is input from an external sensor to the CPU 19a, and the LED 26b lights up or blinks under the indication control of the CPU 19a and indicates red, for example. In one example, when the current value of the battery 5 exceeds 20 [A], the LED 26b blinks ten times at a cycle of 5 Hz. In one example, when the substrate temperature of the control part 19 reaches 80 [° C.], the LED 26b lights up for 3 seconds. In one example, when the temperature of the battery 5 is 90 [° C.] or higher, the LED 26b blinks three times at a cycle of 1 Hz. In one example, when the voltage of the battery 5 is 7.8 [V] or less, the LED 26b blinks ten times at a cycle of 5 Hz. It should be noted that the above values are examples, and there is no limitation to the above values.

In one example, Table 1 below shows the relationship among the operation by the operator, the operation of the electric tool 1, and the operations of the control switch 21, the trigger switch 22, the upper limit switch 23, the intermediate switch 24, and the lower limit switch 25. In Table 1, the first switch is the control switch 21 and the second switch is the trigger switch 22.

TABLE 1

| | | | Control | Trigger | Upper limit | Intermediate | Lower limit |
|---|---|---|---|---|---|---|---|
| Step | Operator | Electric tool | switch | switch | switch | switch | switch |
| | — | Power OFF | OFF | OFF | OFF | ON | OFF |
| S1 | Presses and releases | Power ON, and enabeled | →ON→OFF | OFF | OFF | ON | OFF |
| | the first switch | the second switch | | | | | |
| S2 | Attaches the work | Grips the work | OFF | OFF | OFF | ON | OFF |
| S3 | Grips the trigger lever | Crimps the work | OFF | ON | OFF | OFF | →ON |
| S4 | Releases the trigger | Opens the tool head | OFF | OFF | →ON | OFF | OFF |
| | lever | | | | | | |
| S5 | Removes the work | After a period from release | OFF | OFF | OFF | ON | OFF |
| | | the trigger lever, the power | | | | | |
| | | OFF | | | | | |

As shown in Table 1, while the simple configuration in which the control switch 21 and the trigger switch 22 in conjunction with the trigger lever 27 are combined is provided, the usability is satisfactory because the operator can easily perform a series of necessary operations with one hand. Moreover, the power is turned ON when the control switch 21 is actuated, and the power is turned OFF after a predetermined period from the time when the trigger lever 27 is released, which is rational. In one example, the power is turned OFF 60 seconds after the trigger lever 27 is released.

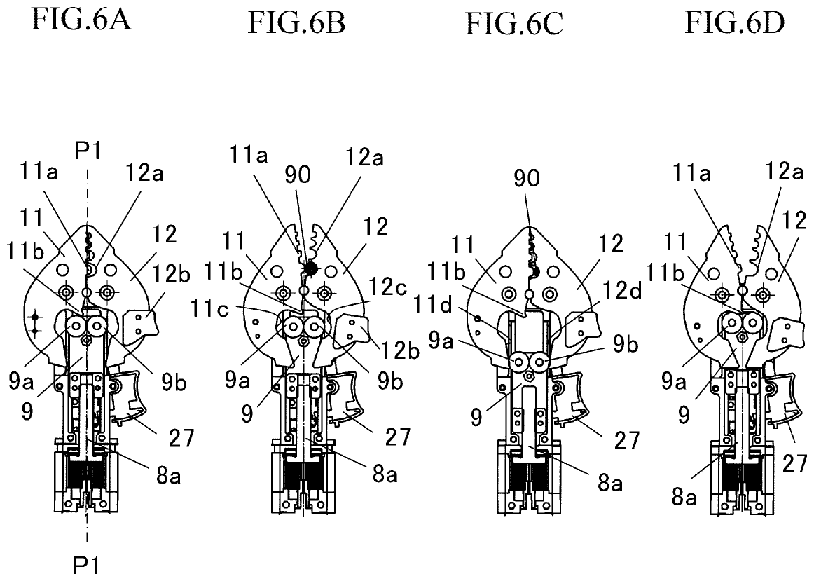

FIGS. 6A to 6D are schematic structural diagrams illustrating the operation of the electric tool 1. The operation of the electric tool 1 is described below with reference to FIGS. 6A to 6D and Table 1.

FIG. 6A shows the initial state in which the slide part 9 is at the intermediate position. The intermediate position is a position at which the first roller 9a is in contact with or adjacent to the projecting part 11b. When the power is OFF, only the intermediate switch 24 is ON. When the slide part 9 is at the intermediate position, the restoring force of the spring 18 closes the distal end side of the first jaw 11 and the distal end side of the second jaw 12. The first crimping operation starts from the initial state of the slide part 9 shown in FIG. 6A.

At step S1, when the operator presses and releases the control switch 21, the control switch 21 is turned from OFF to ON and then OFF, the power is turned ON under the control of the control part 19, and the actuation of the trigger switch 22 is enabled.

Following step S1, at step S2, the operator presses the operation part 12b of the second jaw 12 in the direction of the first jaw 11, so that the first shape part 11a is separated from the second shape part 12a, and the operator attaches the work 90. FIG. 6B shows a state in which the work 90 is held between the first shape part 11a and the second shape part 12a.

Following step S2, at step S3, when the operator grips the trigger lever 27, the slide part 9 retracts and moves downward, the first roller 9a slides on the first slide surface 11d, the second roller 9b slides on the second slide surface 12d, and thus the first shape part 11a and the second shape part 12a move closer to each other to crimp the work 90. When the slide part 9 reaches the lower limit position, the lower limit switch 25 is actuated and the slide part 9 temporarily stops. FIG. 6C shows a state in which the work 90 is crimped.

Following step S3, at step S4, when the operator releases the trigger lever 27, the slide part 9 advances and moves upward, and the first roller 9a pushes the projecting part 11b thereby separating the first shape part 11a and the second shape part 12a from each other. When the slide part 9 reaches the upper limit position, the upper limit switch 23 is actuated and the slide part 9 temporarily stops.

Following step S4, at step S5, the operator removes the work 90. FIG. 6D shows a state in which the work 90 is removed. After a predetermined period from when the operator releases the trigger lever 27, the power is turned OFF with the distal end side of the first jaw 11 and the distal end side of the second jaw 12 closed.

In the automatic mode, the crimping operation is repeated from the state shown in FIG. 6D. In the manual mode, the crimping operation is performed one by one from the state shown in FIG. 6A.

According to the present embodiment, the work 90 can be easily aligned by holding the work 90 with a constant force, and the aligned work 90 can be easily processed. Additionally, since the distal end side of the tool head 3 is closed in the initial state in which the slide part 9 is at the intermediate position, the electric tool 1 has a structure that can reduce the burden on the operator and has a high level of safety as compared to conventional products.

In the above example, a situation where a compression terminal or a crimping sleeve is compressed or crimped as the work 90 has been described, but there is no limitation to this example. The present embodiment can be applied to electrical installation tools in general, such as for cutting electric wires and crimping electric wires. Also, in the above example, a configuration in which the battery 5 is detachably attached to the main body 2 in the form of a battery pack has been described, but there is no limitation to this example. The present embodiment may have a configuration in which the battery 5 is built in the main body 2 or a configuration in which both a built-in battery and a battery pack are provided.

The present invention is not limited to the embodiments described above, and various modifications can be made without departing from the scope of the present invention.

1. An electric tool comprising:
a main body including an electric motor, a feed screw to be actuated by the electric motor, a slide part to be moved by the feed screw, and a control part; and
a tool head that is coupled to the main body and includes a first jaw and a second jaw pivotally coupled to each other,
wherein the tool head is provided with a spring that urges a distal end side of the first jaw and a distal end side of the second jaw in directions toward each other, and processes a work with a first shape part on the distal end side of the first jaw and a second shape part on the distal end side of the second jaw,
the slide part is provided with a first roller at a position slidable to a rear end side of the first jaw, and provided with a second roller at a position slidable to a rear end side of the second jaw,
when the slide part is at an intermediate position, the rear end side of the first jaw and the first roller are separated, the rear end side of the second jaw and the second roller are separated, and the distal end side of the first jaw and the distal end side of the second jaw are urged by the spring and closed, and
by retracting and moving the slide part, the first roller slides on the rear end side of the first jaw, the second roller slides on the rear end side of the second jaw, and the first shape part and the second shape part are brought closer to each other to process the work.

2. The electric tool according to claim 1, wherein the second jaw is provided with an operation part that, when operated by an operator while the slide part is at the intermediate position, separates the first shape part and the second shape part from each other so as to allow the work to be removed.

3. The electric tool according to claim 2, wherein the main body is provided with a trigger switch that is actuated in conjunction with a trigger lever operated by the operator so that the control part drives the electric motor, and a control switch that is actuated by operation by the operator so that the control part enables actuation of the trigger switch.

4. The electric tool according to claim 1, wherein the main body is provided with an upper limit switch that is actuated by movement of the slide part to an upper limit position so that the control part stops the electric motor, an intermediate switch that is actuated by movement of the slide part to the intermediate position so that the control part stops the electric motor, and a lower limit switch that is actuated by movement of the slide part to a lower limit position so that the control part stops the electric motor.

5. The electric tool according to claim 1, wherein the feed screw is supported by a bearing and coupled to the electric motor via a speed reducer.

6. The electric tool according to claim 1, wherein the main body includes a battery that supplies electric power to the electric motor and drives the electric motor with electric power from the battery to compress, crimp, or cut the work.

7. An electric tool comprising:
a main body including an electric motor, a feed screw to be actuated by the electric motor, a slide part to be moved by the feed screw, and a control part; and
a tool head that is coupled to the main body and includes a first jaw and a second jaw pivotally coupled to each other,
wherein the tool head is provided with a spring that urges a distal end side of the first jaw and a distal end side of the second jaw in directions toward each other, and processes a work with a first shape part on the distal end side of the first jaw and a second shape part on the distal end side of the second jaw,
the slide part is provided with a first roller at a position slidable to a rear end side of the first jaw, and provided with a second roller at a position slidable to a rear end side of the second jaw, and
the control part performs control that, after retracting and moving the slide part to a position that can process the work and then processing the work, advances and moves the slide part to a position that allows the processed work to be removed.

8. The electric tool according to claim 7, wherein the main body includes a trigger switch, a control switch, and an intermediate switch that is actuated by movement of the slide part to an intermediate position, and, in response to the control switch being operated by an operator when the intermediate switch is in an ON state, the control part performs control that switches between an automatic mode that repeatedly performs operation of processing the work from a state in which the distal end side of the first jaw and the distal end side of the second jaw are open, and a manual mode that performs operation of processing the work one by one from a state in which the distal end side of the first jaw and the distal end side of the second jaw are closed.

9. The electric tool according to claim 8, wherein in response to the trigger switch being operated by the operator, the control part drives and controls the electric motor, processing of the work becomes possible when the trigger switch is in an ON state, in response to the intermediate switch being actuated, the control part performs stop control of the electric motor, and removal of the processed work becomes possible when the electric motor is in a stopped state.

10. The electric tool according to claim 7, wherein the main body includes a lower limit switch that is actuated by movement of the slide part to a lower limit position, and an upper limit switch that is actuated by movement of the slide part to an upper limit position, when the lower limit switch is in an ON state, the work is in a processed state, and after the work is processed, removal of the processed work becomes possible when the upper limit switch is in an ON state.

11. The electric tool according to claim 7, wherein the main body includes a battery that supplies electric power to the electric motor and drives the electric motor with electric power from the battery to compress, crimp, or cut the work.
